(19) United States
(12) Patent Application Publication
(10) Pub. No.: US 2004/0190442 A1
(43) Pub. Date: Sep. 30, 2004

(54) Gatekeeper cluster and method for operating the same in communication system

(75) Inventor: Young Sin Lee, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/743,803

(22) Filed: Dec. 24, 2003

(30) Foreign Application Priority Data
Dec. 30, 2002 (KR) 10-2002-0086534

(51) Int. Cl. H04L 12/26

(52) U.S. Cl. 370/217; 370/250

(57) ABSTRACT

A structure of a gatekeeper cluster and method for operating the gatekeeper cluster provides reliability and parallel processing using H.323 alternative gatekeeper signaling in a communication system. One zone is divided into one or more sub-zones in the communication system. Each sub-zone provides redundancy by means of one or more alternative gatekeepers. A pass between respective sub-zones provides redundancy by means of one ore more routes. Thereby, a dispersion function is provided on the basis of a backup function. Thus, it is possible to provide a server with stability, and to facilitate IP telephony by providing redundancy and performing backup and dispersion functions of the gatekeeper between the sub-zones.

### BACKGROUND OF THE INVENTION

1. Field of the Invention

The present invention generally relates to a communications system, and more particularly to gatekeeper cluster and method for operating the same in a communication system.

2. Background of the Related Art

It is important to impart stability to a server in order to make Internet Protocol (IP) telephony widely applicable in a communication system. As a scheme for doing so, redundancy may be taken as example. Such redundancy may be provided as a backup function of the server and a dispersion function of distributing a call processing load to several locations. Redundancy is often exemplified by a scheme based on an Open System Interconnect (OSI) IP layer and a scheme based on an OSI application layer.

The scheme using the OSI IP layer has an advantage in that it can be operated independently of application programs for a Voice over IP (VoIP) such as H.323, Session Initiation Protocol (SIP). One disadvantage, however, is that H.323 is not suitable for use as a general model because of restrictions on network environment the hardware platform of the server.

FIG. 1 shows how redundancy may be performed using IP takeover signaling. In an OSI IP layer, redundancy is realized only at a platform where the gatekeeper is operated but is operated independently of the application protocol such as the H.323.

As shown in FIG. 1, there are two types of gatekeepers (GKs) 101 and 103. Gatekeeper 101 is of a master platform in operation and Gatekeeper 103 of a standby platform. Each platform has its own IP address, and the IP of the mast platform which a terminal 105 approaches is defined as the floating IP.

The master platform performs a gratuitous Address Resolution Protocol, (ARP) by which an ARP response informing a Media Access Control (MAC) address of the master platform even without getting an ARP request for the floating IP is transmitted over a broadcast before an ARP entry of the system located at a network segment like the master platform itself is expired.

Meanwhile, heartbeat signaling is used to determine which platform becomes a master platform. Through heartbeat signaling, the standby platform executes periodical polling of the master platform. Further, when the master platform does not respond to a polling message of the standby platform, the standby platform operates as the master platform to perform gratuitous ARP to the floating IP. As such, ARP entry for the floating IP of terminal 105 is changed, so that a message can be continuously transmitted to a new master platform. As a result, redundancy is provided.

Redundancy using IP takeover signaling has an advantage in that it can assist in providing redundancy without realizing additional H.323 signaling relative to terminal 105 and gatekeepers 101 and 103. However, redundancy using IP takeover signaling has a disadvantage in that it is not suitable for general use because a router 107 of a gatekeeper network segment processes gratuitous ARP packets, because standby gatekeeper 103 is located at the network segment like master gatekeeper 101, and because of hardware restriction like the floating IP.

Redundancy using H.323 based signaling will be described as follows. In order to become independent of network restrictions like IP takeover and hardware restrictions, it is possible to use H.323 signaling to induce the terminal to perform H.225 Registration Admission Status (RAS) signaling with other gatekeepers. Here, redundancy may be divided into a method of managing a backup gatekeeper list at the terminal and a method of managing a backup list at the gatekeeper.

In performing the method of providing a backup gatekeeper list at a terminal, after setting up master and standby servers statically, terminal 105 attempts signaling toward standby gatekeeper 103 when master gatekeeper 101 does not respond to an RAS message. This method, however, has a disadvantage in that it is impossible for terminal 105 to provide redirection to the master gatekeeper when attempting signaling toward the standby gatekeeper due to a delay or loss of the RAS message. Thus, a problematic master gatekeeper 101 cannot be constructed as the standby gatekeeper 103 again.

The method of providing a backup list at a gatekeeper uses an alternative gatekeeper of the RAS message. As shown in FIG. 2, alternative gatekeepers 201 and 203 include information on the gatekeeper list which can be used for backup, and include the RAS message transmitted to a terminal 205.

If a kind of IP heartbeat signaling is implemented between master keeper 201 and standby gatekeeper 203, the standby gatekeeper is not recognized as the master gatekeeper even when the RAS message is lost or delayed, and the problematic master gatekeeper 201 operates on standby automatically.

Meanwhile, signaling of alternative gatekeepers 201 and 203 has a generality expandable to a dispersion mode. In other words, when load distribution signaling is implemented between alternative gatekeepers 201 and 203 instead of heartbeat signaling, terminals 205 and 213 in a zone may be registered at the alternative gatekeepers 201 and 203, respectively. Thus, each of the gatekeepers of the zone may have capability increased 0(n) times.

Load distribution signaling has a problem in that, because terminals 205 and 213 dynamically change and register the alternative gatekeepers 201 and 203, to make any one of terminals 205 and 213 registered only at any one of the alternative gatekeepers 201 and 203 at one moment, overhead signaling between the alternative gatekeepers 201 and 203 for each RAS message is generated to incur a signaling delay.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present to provide a gatekeeper cluster structure and method for operating the same, adapted to provide reliability and parallel processing using H.323 alternative gatekeeper signaling in a communication system.

Another object of the present to functionally divide one H.323 zone into one or more H.323 sub-zones to provide a gatekeeper with backup and dispersion functions in a structure of a gatekeeper cluster of a communication system.

Another object of the present to guarantee stability and performance of a communication system, by dividing one H.323 zone into one or more H.323 sub-zones in a structure of a gatekeeper cluster of a communication system, providing redundancy of each sub-zone by means of a gatekeeper consisting of one master gatekeeper and one or more standby gatekeepers, providing redundancy of a pass between the sub-zones different from each other by means of one or more routes, and providing dispersion call processing function between different sub-zones based on a backup function.

In order to accomplish these objects, there is provided a gatekeeper cluster comprising one zone divided into at least two sub-zones in a communication system, at least one alternative gatekeeper providing redundancy for each sub-zone, and at least one route providing redundancy for a pass between the sub-zones, wherein the redundancy provides a dispersion function based on a backup function. Preferably, the alternative gatekeeper provides redundancy by means of one master gatekeeper and at least one standby gatekeeper, the master gatekeeper by itself operating as the gatekeeper of the sub-zone thereof. Further, preferably, the gatekeepers of each sub-zone have a zone routing table. More preferably, the zone routing table is used to determine to which zone a call is routed with reference to a telephone number of a callee when there is no desired number in the zone managed by the gatekeeper.

The zone routing table contains a gatekeeper identifier used for authentication during signaling between the sub-zones, a zone prefix representing a number schedule of each sub-zone, a gatekeeper type indicating any one of the alternative gatekeeper and the gatekeeper of a neighbor zone, and a priority representing a priority of the alternative gatekeepers. More preferably, the gatekeeper identifier is equally given to all the alternative gatekeepers within any one of the sub-zones.

In order to accomplish these objects, there is provided a method for operating a gatekeeper cluster, comprising the steps of dividing one zone into at least two sub-zones in a communication system, providing first redundancy of at least one alternative gatekeeper for each sub-zone, and providing second redundancy of at least one route for a pass between the sub-zones, wherein the redundancy provides a dispersion function based on a backup function. Preferably, the alternative gatekeepers provide redundancy by means of one master gatekeeper and at least one standby gatekeeper, the master gatekeeper by itself operating as the gatekeeper of the sub-zone thereof.

Further, preferably, the redundancy of the alternative gatekeepers comprises the steps of, when the master gatekeeper receives an arbitrary request (xRQ) message from a terminal, searching an alternative type gatekeeper in a routing table, encoding the searched alternative type gatekeeper, transmitting an arbitrary confirm (xCF) message to the terminal, and setting up a call.

Alternatively, the redundancy of the alternative gatekeepers comprises the step of, when the standby gatekeeper receives an arbitrary request (xRQ) message from a terminal, performing heartbeat signaling for master polling in order to check whether the master gatekeeper operates normally.

Preferably, the heartbeat signaling comprising the steps of: at the standby gatekeeper, generating an information request (IRQ) message, transmitting the generated information request message to the master gatekeeper, and checking whether or not there is a response from the master gatekeeper; if there is any response, at the standby gatekeeper, searching an alternative type gatekeeper in a routing table to encode the searched alternative type gatekeeper and transmitting an arbitrary reject (xRJ) message to the requesting terminal; generating an arbitrary request (xRQ) message at the terminal receiving the arbitrary reject (xRJ) message, transmitting the generated arbitrary request (xRQ) message to the master gatekeeper, and requesting to set up a call; and generating an arbitrary confirm (xCF) message at the master gatekeeper receiving the arbitrary request (xRQ) message, transmitting the generated arbitrary confirm (xCF) message to the terminal, and setting up the call.

Further, preferably, the routing table contains a gatekeeper identifier used for authentication during signaling between the sub-zones, a zone prefix representing a number schedule of each sub-zone, a gatekeeper type indicating any one of the alternative gatekeeper and the gatekeeper of a neighbor zone, and a priority representing a priority of the alternative gatekeepers.

Alternatively, the heartbeat signaling further comprises the step of, if there is no response, the standby gatekeeper being changed into the master gatekeeper, searching the alternative type gatekeeper in the routing table, encoding the searched alternative type gatekeeper, transmitting the arbitrary confirm (xCF) message to the terminal, and setting up the call.

Preferably, the heartbeat signaling further comprises the steps of: at the gatekeeper changed into the master gatekeeper, transmitting the arbitrary confirm (xCF) message to grant registration of the terminal, generating a Nonstandard message and transmitting the generated Nonstandard message to other gatekeepers; when the gatekeeper having already operated as the master gatekeeper among the other gatekeepers receives the Nonstandard message, comparing a time of the gatekeeper itself with a time of the Nonstandard message; and if the time of the gatekeeper itself is faster than the time of the Nonstandard message, at the gatekeeper having already operated as the master gatekeeper, generating the Nonstandard message, transmitting the generated Nonstandard message to the gatekeeper changed into the master gatekeeper, and changing into the standby gatekeeper again.

Further, preferably, the step of transmitting the Nonstandard message records a time when the alternative gatekeeper is changed into the master gatekeeper, and informs the other gatekeepers of the recorded time using the Nonstandard message.

More preferably, the heartbeat signaling further comprises the steps of: generating the arbitrary request (xRQ) message at the terminal receiving the arbitrary confirm (xCF) message, transmitting the generated arbitrary request (xRQ) message to the gatekeeper changed into the master gatekeeper, and requesting to set up the call; and when the gatekeeper changed into the master gatekeeper is recognized to be the standby gatekeeper to be changed into the standby gatekeeper again and receives the arbitrary request (xRQ) message, performing again the heartbeat signaling for master polling.

Further, the redundancy of the route comprises the steps of: when the first gatekeeper of the first sub-zone receives the arbitrary request (xRQ) message from the caller terminal of the first sub-zone, checking whether or not a callee number exists in the first sub-zone; if the callee number does not exist in the first sub-zone, at the first gatekeeper, transmitting the arbitrary request (xRQ) message to the second gatekeeper of the second sub-zone with reference to the zone routing table; when the second gatekeeper is the master gatekeeper, generating the arbitrary confirm (xCF) message, transmitting the generated arbitrary confirm (xCF) message to the first gatekeeper, and authenticating the caller terminal; at the authenticated caller terminal, generating a set-up message and transmitting the generated set-up message to the callee terminal of the second sub-zone through the first gatekeeper; at the callee terminal, generating the arbitrary request (xRQ) message and transmitting the generated arbitrary request (xRQ) message to the first gatekeeper through the second gatekeeper; at the first gatekeeper, generating the arbitrary confirm (xCF) message containing signaling information of the first gatekeeper and transmitting the generated arbitrary confirm (xCF) message to the callee terminal through the second gatekeeper; at the callee terminal, generating an alerting message and transmitting the generated alerting message to the caller terminal through the second and first gatekeepers; at the callee terminal, generating a connect message and transmitting the generated connect message to the caller terminal through the second and first gatekeepers; and transceiving H.245 signaling between the callee terminal and the second gatekeeper, between the second gatekeeper and the first gatekeeper and between the first gatekeeper and the caller terminal to allow carrying on a conversation with each other.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 shows a configuration for explaining redundancy using IP takeover signaling in a communication system;

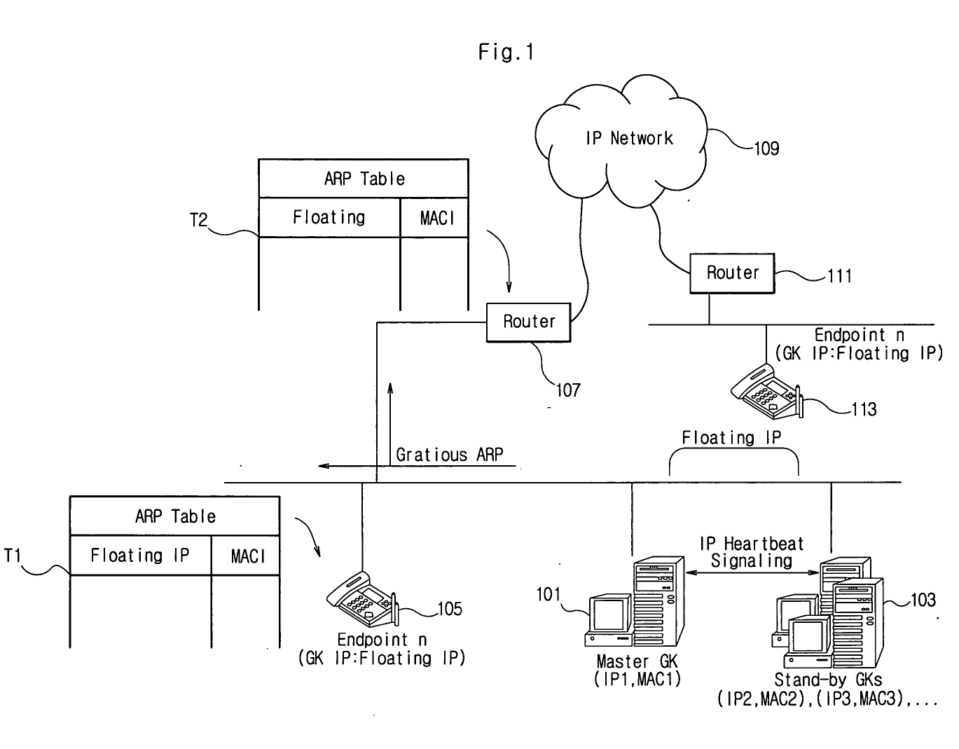

FIG. 2 shows a configuration for explaining redundancy using alternative gatekeeper signaling in a communication system;

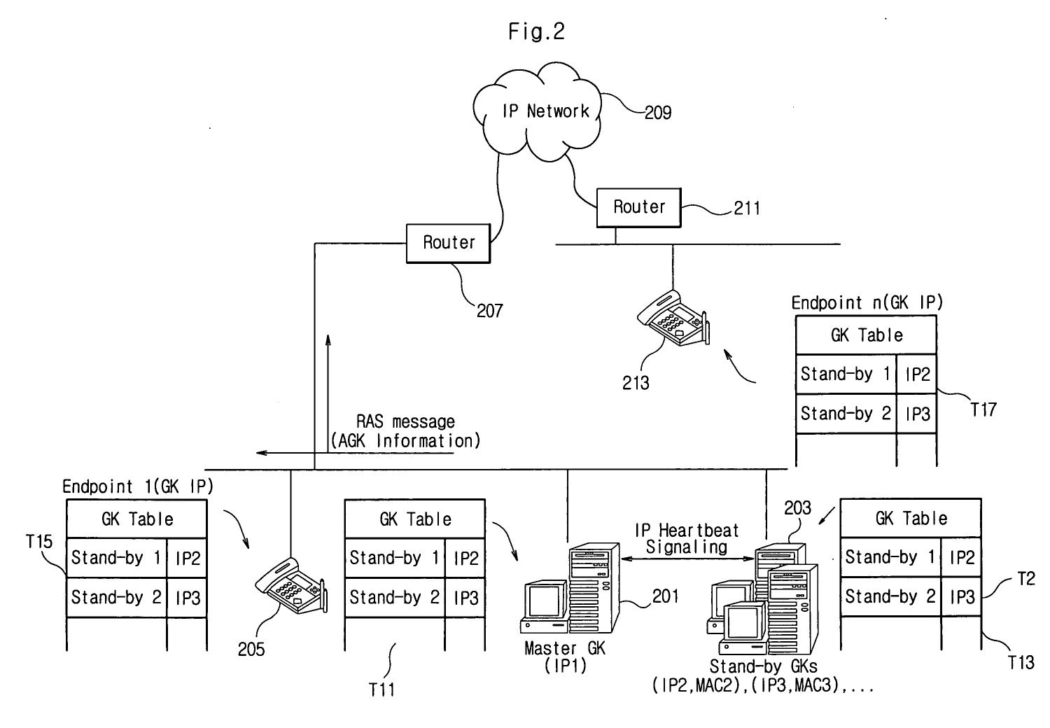

FIG. 3 shows a structure of a gatekeeper cluster in a communication system according to a preferred embodiment of the present invention;

FIG. 4 is a flow diagram illustrating signaling for setting up a call between sub-zones according to a preferred embodiment of the present invention;

FIG. 5 is a flow diagram illustrating heartbeat signaling according to a preferred embodiment of the present invention; and

FIG. 6 illustrates a structure of an interschool network to which a preferred embodiment of the present invention is applied.

### DETAILED DESCRIPTION OF PREFERRED EMBODIMENTS

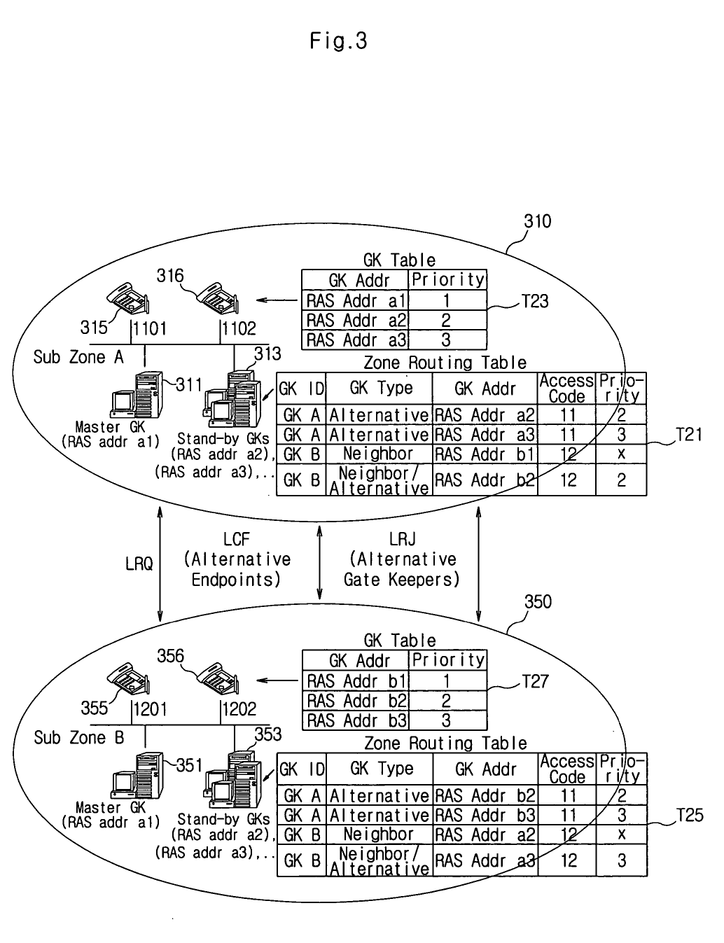

Referring to FIG. 3, the present invention provides a structure of a gatekeeper cluster which is capable of guaranteeing stability and performance by providing a dispersion function based on a backup function in a communication system. The gatekeeper cluster structure functionally divides one H.323 zone into one or more H.323 sub-zones 310 and 350, and then provides gatekeepers (GKs) 311 and 313, and 351 and 353, located within the respective allocated sub-zones 310 and 350 with backup and dispersion functions. Each of the sub-zones 310 and 350 provides redundancy by means of one or more alternative gatekeepers 311 and 313, and 351 and 353. A pass between the sub-zones 310 and 350 provides redundancy by means of one or more routes.

A call between sub-zones 310 and 350 makes use of both a gatekeeper routing table and Location Request/Location Confirm (LRQ/LCF) signaling. The gatekeeper routing table contains addresses and access codes of the gatekeepers of the neighbor sub-zones 310 and 350, and is used to select a zone where terminals 315 and 316, and 355 and 356 are registered with a telephone number to perform the LRQ/LCF signaling. And, in the case of providing redundancy of the routes, information of the alternative gatekeepers on LCF/LRJ (Location Reject) is used to update the gatekeeper routing table of the sub-zones 310 and 350.

The alternative gatekeepers 311 and 313, and 351 and 353, of the respective sub-zones 310 and 350 provide redundancy by means of any one of master gatekeepers 311 and 351 and one or more standby gatekeepers 313 and 353. Here, only the master gatekeeper 311 or 351 operates as a gatekeeper of the sub-zone 310 or 350.

Heartbeat signaling for master polling between the alternative gatekeepers 311 and 313, and 351 and 353, makes use of an IRQ/IRR (Information Response) message. Redundancy of the gatekeeper is provided to make use of information on the alternative gatekeeper of the RAS message transmitted to the terminals 315 and 316, and 355 and 356.

Each of the gatekeepers 311 and 313, and 351 and 353, of the sub-zones 310 and 350 has zone routing tables T21 and T25. The routing tables T21 and T25 is used to determine to which zone a call is routed with reference to a telephone number of a callee in the case where a desired number (e.g., ‘11’ or ‘12’) does not exist in the zone managed by the alternative gatekeepers 311 and 313; and 351 and 353. Further, the routing tables T21 and T25 contain a gatekeeper identifier (GK ID), a zone prefix, a gatekeeper type, and a priority.

The gatekeeper identifier (GK ID) is used for authentication during signaling between the sub-zones 310 and 350. All the alternative gatekeepers 311 and 313, and 351 and 353, within the same sub-zones 310 and 350 have the same gatekeeper identifier (GK ID). The zone prefix represents a number schedule of the sub-zones 310 and 350. What the zone prefix is ‘11’ means that the terminals 315 and 316 having a number range starting with ‘11’ are managed in the related sub-zone 310. The gatekeeper type is divided into alternative, neighbor and neighbor/alternative, wherein the alternative type indicates the alternative gatekeepers 311 and 313, and 351 and 353, the neighbor type indicates the gatekeeper of the neighbor zone, and the neighbor/alternative type indicates the standby gatekeeper of the neighbor zone. The priority represents a priority of the alternative gatekeepers 311 and 313, and 351 and 353.

Signaling between zones in the H.323 is configured to use LRQ/LCF. Further, LRQ/LCF signaling is used to acquire signaling information on unregistered terminals and is configured to be capable of being used between the sub-zones 310 and 350 of the cluster.

A method for operating a gatekeeper cluster in a communication system according to a preferred embodiment of the present invention will now be described. In the gatekeeper cluster, one H.323 zone is functionally divided into one or more H.323 sub-zones in order to provide backup and dispersion functions. Each sub-zone is then subjected to redundancy between one or more alternative gatekeepers, wherein the alternative gatekeepers provide redundancy by means of one master gatekeeper and one or more standby gatekeepers. Here, only one master gatekeeper operates as the gatekeeper of the corresponding sub-zone. Further, a pass between the respective sub-zones provides redundancy by means of one or more routes.

Operation of the gatekeeper redundancy will now be described. Here, operation of the gatekeeper redundancy may be divided into the case where a master gatekeeper receives an arbitrary request (xRQ) message and the case where a standby gatekeeper receives an arbitrary request (xRQ) message.

In the case where a master gatekeeper receives an arbitrary request (xRQ) message from a terminal, the master gatekeeper searches an alternative type gatekeeper in a routing table to encode the searched alternative type gatekeeper, and then transmits an arbitrary confirm (xCF) message to the requesting terminal.

By contrast, in the case where a standby gatekeeper receives an arbitrary request (xRQ) message from a terminal, the standby gatekeeper performs heartbeat signaling for master polling in order to check whether the master gatekeeper operates normally. To this end, an information request (IRQ) message is generated and transmitted to the master gatekeeper. Then, it is checked whether or not there is a response from the master gatekeeper. If there is any response, the standby gatekeeper searches an alternative type gatekeeper in a routing table to encode the searched alternative type gatekeeper, and then transmits an arbitrary reject (xRJ) message to the requesting terminal. However, if there is no response, the standby gatekeeper searches an alternative type gatekeeper in a routing table to encode the searched alternative type gatekeeper, and then transmits an arbitrary confirm (xCF) message to the requesting terminal.

In other words, in the case where a Registration Admission Status (RAS) message is received, the standby gatekeeper induces the RAS to the master gatekeeper using an alternative gatekeeper signaling. At this time, ‘AlternateGK’ is contained when the alternative gatekeeper transmits a GCF/RCF message to the terminal, and consists of RAS addresses of related alternative gatekeepers and ‘priority’ information representing the priority between the related alternative gatekeepers. And, ‘AltGKInfo’ is contained when the alternative gatekeeper transmits the xRJ message, and consists of the ‘AlternateGK’ information and ‘altGKisPermanent’ information. Here, ‘altGKisPermanent’ information is a field indicating whether or not the terminal continues to perform RAS signaling with the selected alternative gatekeeper when performing the RAS signaling.

More specifically, if a value of ‘altGKisPermanent’ is false, the terminal performs the signaling to each RAS message with another alternative gatekeeper. However, if true, the terminal performs the signaling to all RAS messages with one alternative gatekeeper.

Description will be made below regarding heartbeat signaling using the IRQ/IRR message. An arbitrary standby gatekeeper receives a Registration Request (RRQ) message from the terminal. At this time, in order to check whether the master gatekeeper operates in a normal state, the standby gatekeeper performs polling. The polling is performed when the standby gatekeeper is either booted or receives Gatekeeper Request (GRQ) message, Registration Request (RRQ) message or ARQ message from the terminal.

In other words, for the purpose of polling, the standby gatekeeper generates an IRQ (crv=0) message and transmits the generated IRQ message to the master gatekeeper, and then checks whether there is the Information Response (IRR) message received from the master gatekeeper. Here, if there is the IRR message, the standby gatekeeper determines that the master gatekeeper operates normally.

However, in the case where the standby gatekeeper does not check the IRR message received from the master gatekeeper, the standby gatekeeper checks whether an IRQ timer is terminated in the state of not receiving the IRR message to be intended to operate as the master gatekeeper. Here, if the polling message is lost and the standby gatekeeper is two or more, two or more alternative gatekeepers operate as the master gatekeeper. As a result, conflicts occur between the master gatekeepers.

For this reason, conflicts between master gatekeepers are avoided using the time when the alternative gatekeepers were converted into the master gatekeepers. In other words, each alternative gatekeeper, which was converted into the master gatekeeper, records the time done so, and then informs other alternative gatekeepers of the recorded time using an H.225 Nonstandard message.

And, the alternative gatekeeper operating as the master gatekeeper compares the recorded time with the time of the Nonstandard message. If the time of the Nonstandard message is faster than the recorded time, the alternative gatekeeper operates as the standby gatekeeper. However, if the recorded time is faster than the time of the Nonstandard message, the alternative gatekeeper transmits the Nonstandard message to the corresponding alternative gatekeeper, thus allowing the corresponding alternative gatekeeper to operate as the standby gatekeeper.

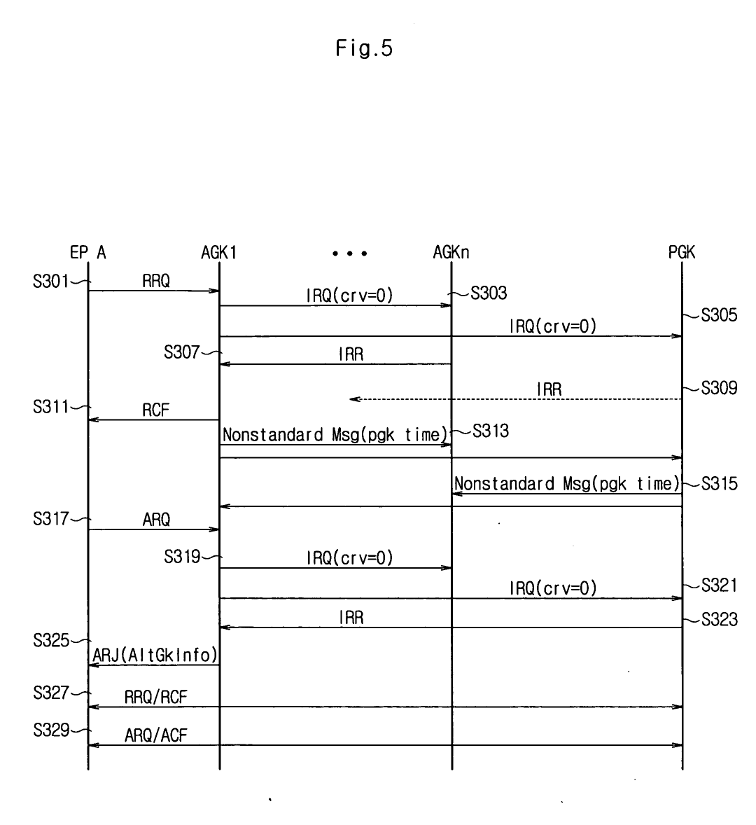

FIG. 5 shows how conflicts between master gatekeepers can be avoided in heartbeat signaling. More specifically, FIG. 5 shows an operation performed to avoid conflicts between master gatekeepers when a first terminal EPA transmits RAS messages to a standby gatekeeper AGK1

First, after the standby gatekeeper AGK1 receives the RRQ message from the first terminal EPA (S301), in order to check whether or not master gatekeepers AGKn and PGK operates normally, the standby gatekeeper AGK1 generates the IRQ (crv=0) message and transmits the generated IRQ message to the master gatekeepers AGKn and PGK (S303 and S305).

Thus, the standby gatekeeper AGK1 checks whether there is the IRR message received from the master gatekeeper AGKn. Here, if the IRR message is received, the standby gatekeeper AGK1 determines that the master gatekeeper AGKn operates normally (S307).

However, in the case where the standby gatekeeper AGK1 does not check the IRR message received from the master gatekeeper PGK, the standby gatekeeper checks whether an IRQ timer is terminated. Here, even though the IRR message transmitted from the master gatekeeper PGK is lost, the standby gatekeeper AGK1 operates as the master gatekeeper (S309).

Then, the standby gatekeeper AGK1 operates as the master gatekeeper to generate the RCF message, transmits the generated RCF message to the first terminal EPA, and permits registration of the first terminal EPA (S311). Further, the standby gatekeeper AGK1 generates an H.225 Nonstandard message for informing operation as the master gatekeeper and transmits the generated message to the registered alternative gatekeepers AGKn and PGK. In other words, the standby gatekeeper AGK1 records the time when conversion into the master gatekeeper takes place, and informs other alternative gatekeepers AGKn and PGK of the recorded time using the H.225 Nonstandard message (S313).

However, the master gatekeeper PGK which has already operated as the master gatekeeper compares the recorded time with the time of the Nonstandard message received from the alternative gatekeeper AGK1. If the time of the Nonstandard message is faster than the recorded time, the alternative gatekeeper operates as the standby gatekeeper. However, if the recorded time is faster than the time of the Nonstandard message, the master gatekeeper PGK determines itself to be the master gatekeeper, generates the Nonstandard message again, and transmits the generated Nonstandard message to the alternative gatekeeper AGK1 (S315).

And, the Nonstandard message is transmitted to the alternative gatekeeper AGK1 without any error, so that the master gatekeeper PGK is allowed to operate as the standby gatekeeper again.

Meanwhile, the first terminal EPA, which receives the RCF message from the alternative gatekeeper AGK1 to be registered, generates an Admission Request (ARQ) message for setting up a call and transmits the generated ARQ message to the alternative gatekeeper AGK1 (S317).

Thus, the alternative gatekeeper AGK1 receives the ARQ message from the first terminal EPA. At this time, because the alternative gatekeeper AGK1 operates as the standby gatekeeper, the alternative gatekeeper AGK1 performs polling again in order to check whether the master gatekeeper PGK operates normally.

In other words, the standby gatekeeper AGK1 generates an IRQ (crv=0) message for the purpose of polling and transmits the generated IRQ message to the master gatekeepers AGKn and PGK (S319 and S321), and then checks whether or not there is the IRR message received from the master gatekeeper. Here, the IRR message reaches the standby gatekeeper AGK1 without any error (S323).

Thus, the standby gatekeeper AGK1 receives the IRR message from the master gatekeeper PGK to generate an Admission Reject (ARJ) message, and transmits the generated ARJ message to the first terminal EPA (S325).

Then, the first terminal EPA generates an RRG/RCF message and transmits the generated RRG/RCF message to the master gatekeeper PGK (S327). Then, the first terminal EPA receives an ARQ/ACF message from the master gatekeeper PGK to set up the call (S329).

In this case, the master gatekeeper PGK directly transmits xCF messages (e.g., RXF message, ACF message, etc.) to the first terminal EPA without polling the standby gatekeeper AGK1.

Operation of route redundancy will now be described. First, when gatekeepers of other zones receive neighbor authentication, a routing table is searched with a gatekeeper identifier and a caller telephone number of received LRQ message to perform the neighbor authentication.

Here, the alternative gatekeeper searches an alternative type gatekeeper in the routing table, and either encodes an alternative terminal field AltEp depending on whether or not the authentication ends in success to generate an LCF message and then transmits the generated LCF message to the gatekeeper requesting the authentication, or encodes an alternative gatekeeper field AltGK to generate an LRJ message and then transmits the generated LRJ message to the gatekeeper requesting the authentication.

Then, when the LCF message is received from the alternative gatekeeper, the gatekeeper requesting the authentication corrects related zone information in the routing table with the alternative terminal field AltEp.

When the LRG message is received form the alternative gatekeeper, the gatekeeper requesting the authentication checks whether the alternative gatekeeper field AltGK exists in the received LRJ message. If the alternative gatekeeper field AltGK does not exist, a reject (xRJ) message is transmitted to a terminal.

If the alternative gatekeeper field AltGK exists and a value of the corresponding LRJ Reason is ‘Request Denied,’ the gatekeeper requesting the authentication corrects the type of the gatekeeper transmitting the LRQ message into ‘Neighbor/Alternative.’ Further, the gatekeeper requesting the authentication corrects the type of the gatekeeper having the highest priority in the received alternative gatekeeper field AltGK into ‘Neighbor,’ and corrects the routing table by means of a value of the received alternative gatekeeper field AltGK, and retransmits the LRQ message.

Then, if there is no response to the LRQ message, it is checked whether or not a ‘Neighbor/Alternative’ type gatekeeper of the related zone exists in the routing table. Here, if the ‘Neighbor/Alternative’ type gatekeeper does not exist, an arbitrary reject (xRJ) message is transmitted to the terminal. However, if the ‘Neighbor/Alternative’ type gatekeeper exists, the gatekeeper having the highest priority is changed into a ‘Neighbor,’ and then the LRQ message is transmitted again.

If the master gatekeeper receives the LRQ message, the neighbor authentication is performed like the foregoing operation. Then, if the authentication ends in success, the LCF message is transmitted like the foregoing operation. However, if the authentication ends in failure, the LRJ message is transmitted like the foregoing operation.

By comparison, if the standby gatekeeper receives the LRQ message, the polling of the master gatekeeper is performed as mentioned above. Then, if the master gatekeeper is alive, the LRJ message is transmitted like the foregoing operation. However, if the master gatekeeper is dead, the standby gatekeeper itself functions as the master gatekeeper, and the previous type of the master gatekeeper is changed into the ‘Alternative.’ Then, the LCF message is transmitted like the foregoing operation.

Meanwhile, signaling for setting up the call between the sub-zones includes LRQ signaling, wherein redundancy of routes between the zones may be provided using AlternativeEndpoints of the LCF message and alternative gatekeeper fields AlternateGKs of the LRJ message. Here, the AlternativeEndpoints are contained in the ACF and LCF messages, and are fields indicating other alternative addresses for a server transmitting an xCF message.

Therefore, the ‘AlternativeEndpoints’ field of the LCF message gives the addresses of the alternative gatekeepers of its own zone to a foreign sub-zone. In other words, the gatekeeper getting the LCF/LRJ message records the ‘AlternativeEndpoint’ information and the ‘AltGKinfo’ information in the zone routing table, and attempts the LRQ signaling to the recorded standby gatekeeper again.

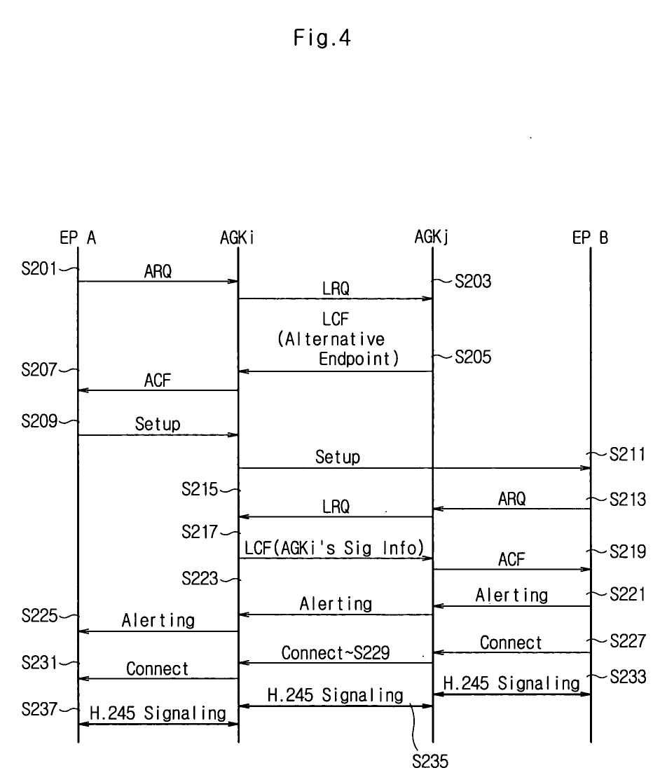

FIG. 4 shows signaling for setting up the call between the sub-zones. First, a first gatekeeper AGKi of a first sub-zone A receives an Admission Request (ARQ) message from a first terminal EPA (S201), and checks whether or not a callee number exists in its own sub-zone from the received ARQ message. Then, if the callee number does not exist in its own sub-zone, the first gatekeeper AGKi makes reference to a zone routing table.

Here, the first gatekeeper AGKi generates a Location Request (LRQ) message with reference to the zone routing table and transmits the generated LRQ message to a second gatekeeper AGKj of a second sub-zone B. The first gatekeeper AGKi attaches both a telephone number of the first terminal EPA and its own zone prefix to a field of a source or caller number of the LRQ message, records the attached result, and transmits the LRQ message (S203).

Then, the second gatekeeper AGKj receives the LRQ message from the first gatekeeper AGKi. Here, if the second gatekeeper AGKj is in a standby state, the second gatekeeper AGKj performs polling of the master gatekeeper and passes through an authentication procedure, and then generates and transmits an LCF/LRJ message. However, if the second gatekeeper AGKj itself is the master gatekeeper, the second gatekeeper AGKj generates a Location Confirm (LCF) message and transmits the generated LCF message to the first gatekeeper AGKi (S205).

Thus, the first gatekeeper AGKi receives the LCF message from the second gatekeeper AGKj, generates an ACF message, and transmits the generated ACF message to the first terminal EPA (S207).

Then, the first terminal EPA receives the ACF message from the first gatekeeper AGKi to generate a set-up message and transmits the generated set-up message to the first gatekeeper AGKi (S209). Therefore, the first gatekeeper AGKi transmits the set-up message received from the first terminal EPA to a second terminal EPB as a callee side (S211).

Thus, the second terminal EPB receives the set-up message from the first gatekeeper AGKi to generate an ARQ message and transmits the generated ARQ message to the second gatekeeper AGKj (S213). Then, the second gatekeeper AGKj receives the ARQ message from the second terminal EPB to generate an LRQ message and transmits the generated LRQ message to the first gatekeeper AGKi (S215).

Here, the first gatekeeper AGKi receives the LRQ message from the second gatekeeper AGKj to generate an LCF message and transmits the generated LCF message to the second gatekeeper AGKj. In this case, the LCF message is transmitted with signaling information of the first gatekeeper AGKi contained.

Therefore, the second gatekeeper AGKj receives the LCF message from the first gatekeeper AGKi to generate an Admission Confirm (ACF) message and transmits the generated ACF message to the second terminal EPB (S219).

Then, the second terminal EPB receives the ACF message from the second gatekeeper AGKj to generate an Alerting message and transmits the generated the Alerting message to the second gatekeeper AGKj (S221). Therefore, the second gatekeeper AGKj transmits the Alerting message to the first gatekeeper AGKi (S223). Further, the first gatekeeper AGKi transmits the Alerting message to the first terminal EPA (S225).

Then, the second terminal EPB generates a connect message and transmits the generated connect message to the second gatekeeper AGKj (S227). Therefore, the second gatekeeper AGKj transmits the connect message to the first gatekeeper AGKi (S229). Further, the first gatekeeper AGKi transmits the connect message to the first terminal EPA (S231).

H.245 signaling is transceived between the second terminal EPB and the second gatekeeper AGKj (S233). The same thing is true of not only between the second gatekeeper AGKj and the first gatekeeper AGKi (S235), but also between the first gatekeeper AGKi and the first terminal EPA (S237). As a result, it is possible to carry on a conversation each other.

Unlikely, the structure of the gatekeeper cluster for the communication system according to a preferred embodiment of the present invention may be applied to an interschool network. Each school of the interschool network is configured of one sub-zone, and is subjected to redundancy with two alternative gatekeepers. The entire calls may be processed by dispersion to each school.

The interschool network, for example, is a project in which about 180 schools perform communication with a Voice over Internet Protocol (VoIP). The communication performed within each school, between the schools and between each school and its outside is based on a public Internet Protocol (IP) network. Each school constructs the network under a Network Address Translation (NAT) environment. In the system for telephone numbers, the communication between the schools is used like an extension number, and thus an additional service available within the school is also applied to the call between the schools.

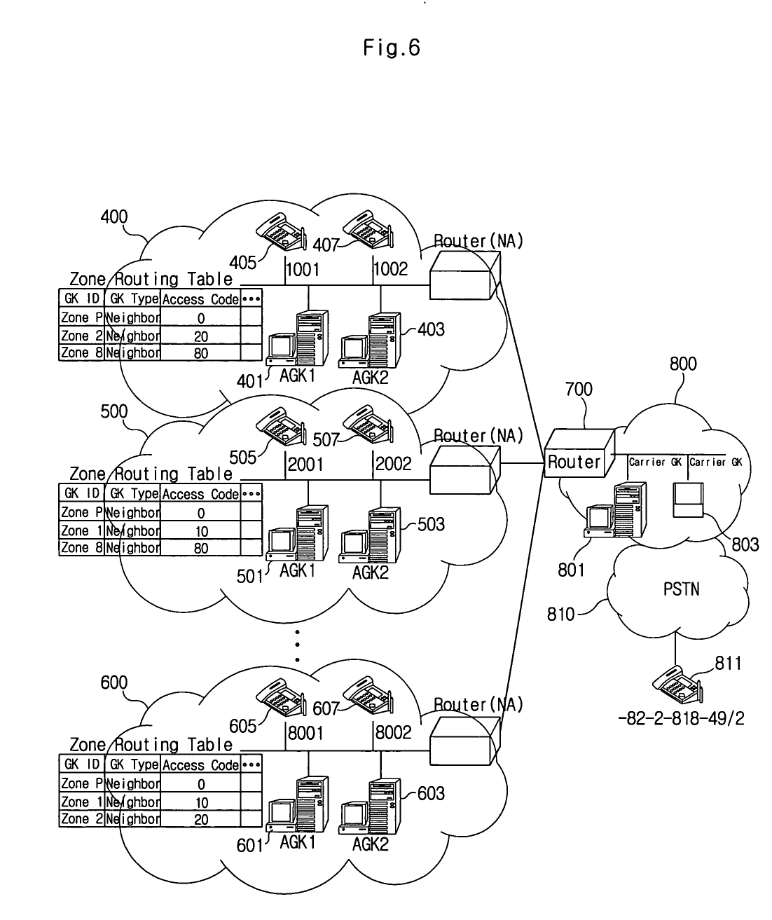

FIG. 6 shows a configuration of an interschool network according to a preferred embodiment of the present invention, in which all of 180 schools are not configured of a single zone but each school is configured of one sub-zone as the structure of the gatekeeper cluster. Here, each of the sub-zones 400, 500, and 600 is operated with two alternative gatekeepers 401 and 403, 501 and 503, and 601 and 603, one Real-time Transport Protocol (RTP) passer (router (NAT)). The RTP passer (router (NAT)) is included in an H.323 proxy structure in order to set up a call to an external zone under the NAT environment.

A zone routing table is to provide redundancy between the zones of each gatekeeper. With reference to the zone routing table, one zone performs routing to any other zone with an access code. In other words, the call is set up to the outside using a carrier gatekeeper 801 over an external Public Switched Telephone Network (PSTN) 810 to carry on a conversation based on the VoIP. The call between the schools is set up through the gatekeepers 401 and 403, 501 and 503, and 601 and 603 between the sub-zones, but not through the carrier gatekeeper 801, to carry on a conversation.

To this end, the zone routing table is recorded by an address of the carrier gatekeeper for the numbers starting with ‘0,’ and by an address of a master gatekeeper for the internal numbers starting with ‘10,’ ‘20,’ etc. in order to perform communication with any other sub-zone even when the internal numbers are not ones managed in their own sub-zone.

As set forth above, for the gatekeeper cluster and method for operating the same in the communication system in accordance with the present invention, one H.323 zone is divided into at least one H.322 sub-zone, each sub-zone provides redundancy by means of at least two gatekeepers, redundancy is provided between the gatekeepers within each sub-zone. Thus, it is possible to provide the server with stability, and to facilitate IP telephony by providing redundancy and performing backup and dispersion functions of the gatekeeper between the sub-zones.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A gatekeeper cluster comprising:
one zone divided into at least two sub-zones in a communication system;
at least one alternative gatekeeper providing redundancy for each sub-zone; and
at least one route providing redundancy for a pass between the sub-zones,
wherein the redundancy provides a dispersion function based on a backup function.

2. The gatekeeper cluster of claim 1, wherein the alternative gatekeeper provides redundancy by one master gatekeeper and at least one standby gatekeeper, the master gatekeeper by itself operating as the gatekeeper of the sub-zone thereof.

3. The gatekeeper cluster of claim 1, wherein the gatekeepers of each sub-zone have a zone routing table.

4. The gatekeeper cluster of claim 3, wherein the zone routing table determines to which zone a call is routed with reference to a telephone number of a callee, when there is no desired number in the zone managed by the gatekeeper.

5. The gatekeeper cluster of claim 3, wherein the zone routing table contains a gatekeeper identifier used for authentication during signaling between the sub-zones, a zone prefix representing a number schedule of each sub-zone, a gatekeeper type indicating any one of the alternative gatekeeper and the gatekeeper of a neighbor zone, and a priority representing a priority of the alternative gatekeepers.

6. The gatekeeper cluster of claim 5, wherein the gatekeeper identifier is equally given to all the alternative gatekeepers within any one of the sub-zones.

7. A method for operating a gatekeeper cluster, comprising:
dividing one zone into at least two sub-zones in a communication system;
providing first redundancy of at least one alternative gatekeeper for each sub-zone; and
providing second redundancy of at least one route for a pass between the sub-zones,
wherein the redundancy provides a dispersion function based on a backup function.

8. The method of claim 7, wherein the alternative gatekeepers provide redundancy by one master gatekeeper and at least one standby gatekeeper, the master gatekeeper by itself operating as the gatekeeper of the sub-zone thereof.

9. The method of claim 8, wherein the redundancy of the alternative gatekeepers comprises, when the master gatekeeper receives an arbitrary request (xRQ) message from a terminal, searching an alternative type gatekeeper in a routing table, encoding the searched alternative type gatekeeper, transmitting an arbitrary confirm (xCF) message to the terminal, and setting up a call.

10. The method of claim 8, wherein the redundancy of the alternative gatekeepers comprises, when the standby gatekeeper receives an arbitrary request (xRQ) message from a terminal, performing heartbeat signaling for master polling in order to check whether the master gatekeeper operates normally.

11. The method of claim 10, wherein the heartbeat signaling comprises:
at the standby gatekeeper, generating an information request (IRQ) message, transmitting the generated information request message to the master gatekeeper, and checking whether or not there is a response from the master gatekeeper;
if there is any response, at the standby gatekeeper, searching an alternative type gatekeeper in a routing table to encode the searched alternative type gatekeeper and transmitting an arbitrary reject (xRJ) message to the requesting terminal;
generating an arbitrary request (xRQ) message at the terminal receiving the arbitrary reject (xRJ) message, transmitting the generated arbitrary request (xRQ) message to the master gatekeeper, and requesting to set up a call; and
generating an arbitrary confirm (xCF) message at the master gatekeeper receiving the arbitrary request (xRQ) message, transmitting the generated arbitrary confirm (xCF) message to the terminal, and setting up the call.

12. The method of claim 11, wherein the routing table contains a gatekeeper identifier used for authentication during signaling between the sub-zones, a zone prefix representing a number schedule of each sub-zone, a gatekeeper type indicating any one of the alternative gatekeeper and the gatekeeper of a neighbor zone, and a priority representing a priority of the alternative gatekeepers.

13. The method of claim 11, wherein the heartbeat signaling further comprises, if there is no response, the standby gatekeeper being changed into the master gatekeeper, searching the alternative type gatekeeper in the routing table, encoding the searched alternative type gatekeeper, transmitting the arbitrary confirm (xCF) message to the terminal, and setting up the call.

14. The method of claim 13, wherein the heartbeat signaling further comprises;
at the gatekeeper changed into the master gatekeeper, transmitting the arbitrary confirm (xCF) message to grant registration of the terminal, generating a Nonstandard message and transmitting the generated Nonstandard message to other gatekeepers;
when the gatekeeper having already operated as the master gatekeeper among the other gatekeepers receives the Nonstandard message, comparing a time of the gatekeeper itself with a time of the Nonstandard message; and
if the time of the gatekeeper itself is faster than the time of the Nonstandard message, at the gatekeeper having already operated as the master gatekeeper, generating the Nonstandard message, transmitting the generated Nonstandard message to the gatekeeper changed into the master gatekeeper, and changing into the standby gatekeeper again.

15. The method of claim 14, wherein transmitting the Nonstandard message comprises:
recording a time when the alternative gatekeeper is changed into the master gatekeeper, and
informing the other gatekeepers of the recorded time using the Nonstandard message.

16. The method of claim 14, wherein the heartbeat signaling further comprises:
generating the arbitrary request (xRQ) message at the terminal receiving the arbitrary confirm (xCF) message, transmitting the generated arbitrary request (xRQ) message to the gatekeeper changed into the master gatekeeper, and requesting to set up the call; and
when the gatekeeper changed into the master gatekeeper is recognized to be the standby gatekeeper to be changed into the standby gatekeeper again and receives the arbitrary request (xRQ) message, performing again the heartbeat signaling for master polling.

17. The method of claim 7, wherein the redundancy of the route comprises:
when the first gatekeeper of the first sub-zone receives the arbitrary request (xRQ) message from the caller terminal of the first sub-zone, checking whether or not a callee number exists in the first sub-zone;
if the callee number does not exist in the first sub-zone, at the first gatekeeper, transmitting the arbitrary request (xRQ) message to the second gatekeeper of the second sub-zone with reference to the zone routing table;
when the second gatekeeper is the master gatekeeper, generating the arbitrary confirm (xCF) message, transmitting the generated arbitrary confirm (xCF) message to the first gatekeeper, and authenticating the caller terminal;
at the authenticated caller terminal, generating a set-up message and transmitting the generated set-up message to the callee terminal of the second sub-zone through the first gatekeeper;
at the callee terminal, generating the arbitrary request (xRQ) message and transmitting the generated arbitrary request (xRQ) message to the first gatekeeper through the second gatekeeper;
at the first gatekeeper, generating the arbitrary confirm (xCF) message containing signaling information of the first gatekeeper and transmitting the generated arbitrary confirm (xCF) message to the callee terminal through the second gatekeeper;
at the callee terminal, generating an alerting message and transmitting the generated alerting message to the caller terminal through the second and first gatekeepers;
at the callee terminal, generating a connect message and transmitting the generated connect message to the caller terminal through the second and first gatekeepers; and
transceiving H.245 signaling between the callee terminal and the second gatekeeper, between the second gatekeeper and the first gatekeeper and between the first gatekeeper and the caller terminal to allow carrying on a conversation with each other.
